(19) United States
(12) Patent Application Publication
(10) Pub. No.: US 2009/0199255 A1
(43) Pub. Date: Aug. 6, 2009

(54) Device and Methods for Customization of Communication Notification In A Converged Network

(75) Inventors: Mehrad Yasrebi, Austin, TX (US); James Jackson, Austin, TX (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 12/023,713

(22) Filed: Jan. 31, 2008

(51) Int. Cl. H04N 7/173

(52) U.S. Cl. 725/118

(57) ABSTRACT

A method for customization of communication session request notifications based on user preference information includes receiving a communication session invitation at a service provider. The service provider determines the intended target of the invitation, and identifies preference information associated with the target. In an embodiment, the preference information is associated with a user of the target communication device. The preference information includes a set of identifiers for multimedia content associated with particular users, groups, regions, or the like, or any combination thereof. Based on the session invitation, the service provider determines a particular identifier and provides the associated multimedia content to the target device. The preference information can be adjusted by a user to customize notifications for requests from particular users, groups, or regions, or any combination thereof.

### FIELD OF THE DISCLOSURE

The present disclosure generally relates to communication networks, and more particularly relates to customization of communication session request notifications over a communication network.

### BACKGROUND

Communication networks have greatly increased in complexity and functionality, so that the network can provide for transmission of a variety of multimedia data and also provide a backbone for person-to-person communication. For example, networks can provide for communication via voice, video, and text. Typically, one user initiates a communication session by sending a session request via a customer device. The network routes the invitation to a target device, which provides a session invitation arrival notification (SAIN) to indicate that a communication session has been requested. Typically, the SAIN depends on the type of communication device that receives the invitation. For example, if the customer device is a phone, the SAIN can be a ring tone.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a communication network in accordance with one aspect of the present disclosure;

FIG. 2 is a block diagram of a particular embodiment of notification preference information of FIG. 1;

FIG. 3 is a block diagram of a particular embodiment of a communication device of FIG. 1;

FIG. 4 is a flow diagram of a particular embodiment of a method of providing a communication session request; and

FIG. 5 is a flow diagram of a particular embodiment of a method of receiving a communication session request at a target device.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

A method and system for customization of communication session request notifications based on user preference information is disclosed. The method includes receiving a communication session invitation at a service provider. The service provider determines the intended target of the invitation, and identifies preference information associated with the target. In an embodiment, the preference information is associated with a user of the target communication device. The preference information includes a set of identifiers for multimedia content associated with particular users, groups, regions, or the like, or any combination thereof. Based on the session invitation, the service provider determines a particular identifier and provides the associated multimedia content to the target device. The preference information can be adjusted by a user to customize notifications for requests from particular users, groups, or regions, or any combination thereof.

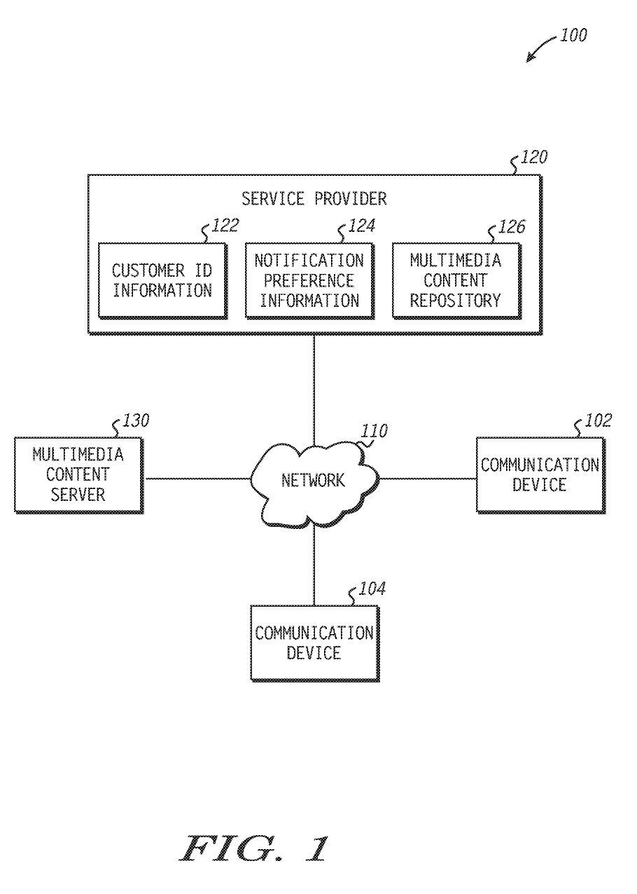

FIG. 1 illustrates a particular embodiment of a communication network 100, including communication devices 102 and 104, a service provider 120, and a multimedia content server 130, each connected to a network 110. The network 110 provides a communication backbone for the devices 102 and 104. In addition, the network 110 provides a backbone for transmission of multimedia data between the communication devices 102 and 104, the multimedia content server 130, and the service provider 120. In a particular embodiment, the network 110 is a packet-switched wide area network including a number of servers, routers, and other equipment to route received packets to their targeted destination. Further, the network 110 can incorporate a number of other networks, such as a telecommunications network, an Internet Protocol television (IPTV) network, or the like. In other embodiments, the network 110 is a local area network.

The communication devices 102 and 104 are devices which provide for person-to-person communication for users of each device, and can be any kind of device which provides for communication via the network 110. Accordingly, the communication devices 102 and 104 may provide for voice communication, video communication, text-based communication, or any combination thereof. For example, the communication devices 102 and 104 can be cell phones, video phones, video chat devices, computers executing a chat program, a set-top box for a television set, or the like. Further, due to the flexibility of the network 110, the communication devices 102 and 104 can be of different types. For example, the communication device 102 can be a computer executing a chat program and the communication device 104 can be a cell phone.

In addition, each of the communication devices 102 and 104 is configured to display multimedia information received via the network 110. As used herein, the terms “display” or “render” refer to providing text and/or multimedia content to any type of human interface. Accordingly, audio data can be displayed or rendered via a speaker, video data displayed or rendered via a monitor, and so on.

The multimedia content server 130 stores a variety of multimedia content, such as audio content, video content, or the like. In response to requests received via the network 110, the multimedia content server 130 provides identified content to the network. It will be appreciated that although the multimedia content server 130 is illustrated as a single server, it can be representative of multiple servers and of multimedia content stored at multiple servers.

The service provider 120 provides access to the network 110 to customers. Accordingly, the service provider 120 implements services to enhance a customer's ability to both retrieve multimedia content from and communicate via the network 110. Such services can include providing a customer device with an entry point to the network 110, providing a security and authentication layer for content providers, providing billing and accounting services, or the like. In one embodiment, the service provider 120 also provides the network 110 for communications. In another embodiment, the network 110 is provided by another service provider or other entity.

The service provider 120 includes customer identification information 122, notification preference information 124, and multimedia content repository 126, each of which can be stored on one or more servers or other computer devices. The customer identification information 122 includes information identifying customers based on address information received via the network 110. For example, the service provider 120 can receive a packet indicative of a request for a communication session. The packet includes information identifying the device targeted by the request, and the service provider 120 can access the customer identification information 122 to determine the customer associated with the target device.

The notification preference information 124 includes data sets associated with customers of the service provider 120. As described further below, each data set indicates one or more identifiers of multimedia items to be displayed at a communication device to indicate a SAIN has been received. The multimedia items can be grouped according to user identification values, user groups, regions, and/or the like.

The multimedia content repository 126 includes audio content, video content, or the like that can be provided via the network 110 to indicate a SAIN has been received. In an embodiment, each item of the multimedia content repository 126 is associated with a unique identifier, such as a universal resource locator (URL). Accordingly, in response to determining the URL for a content item, the service provider 120 can retrieve the item from the multimedia content repository 126 and provide it via the network 110.

In operation, a user of a communication device initiates a communication session by inputting data indicating a target of the session. For example, if the target of the communication session is a cell phone, the user initiates a communication session by entering the phone number associated with the phone at the initiating communication device. For purposes of discussion, the communication device that initiates the communication session is referred to as the initiating communication device, and the communication device that is the target of the session is referred to as the target communication device. Further, for purposes of discussion it is assumed that in the illustrated embodiment of FIG. 1 the communication device 102 is the initiating communication device and communication device 104 is the target communication device. However, it will be appreciated that the communication devices 102 and 104 can both initiate communication sessions and be the target of communication session requests. In response to the user entering the target information at the initiating communication device (i.e. the communication device 102), the device sends a communication session request to the service provider 120 via the network 110.

In response to receiving the session request, the service provider 120 accesses the customer identification information 122 to determine the customer associated with the target communication device (in the example being discussed, the communication device 104). After determining the customer, the service provider 120 accesses the data set at the notification preference information 124 that is associated with the identified customer. Further, the service provider 120 determines whether a particular entry in the data set is associated with the target communication device. Based on this determination, the service provider 120 determines a URL or other identifier for a particular multimedia content item, and provides the identifier to the target communication device, together with a packet indicating that a communication session has been requested. In response to receiving the packet, the target communication device retrieves the multimedia item indicated by the identifier. In the illustrated embodiment of FIG. 1, the target communication device retrieves the content item from the multimedia content repository 126 or from the multimedia content server 130. Upon retrieving the multimedia content, the target communication device displays the content at the target device to indicate the SAIN has been received.

The operation of the communication network 100 can be better understood with reference to an example. In the exemplary operation, a user of the communication device 102 enters information, such as a phone number, user identification value, chat address, email address, or the like, to request a communication session with the communication device 104. In response, the communication device 102, as the initiating communication device, sends a communication session request to the service provider 120.

The communication session request includes information, such as a phone number, Internet address, or the like, that identifies the target communication device, i.e. the communication device 104. Accordingly, in response to receiving the request, the service provider 120 accesses the customer identification information 122 based on the identification information included in the communication request to determine the customer associated with the target customer for the communication device 104. Upon determining the customer, the service provider 120 accesses the data set of the notification preference information 124 associated with that customer. Based on the type of communication device 104, the customer associated with the initiating communication device (communication device 102), the region associated with the communication session request, or other criteria, or any combination thereof, the service provider 120 selects a URL or other identifier in the data set of the notification preference information 124. The service provider 124 communicates the URL to the target communication device 104, which uses the URL to retrieve a multimedia item from the multimedia content server 130 or the multimedia content repository 126. The target communication device 104 then renders the content to indicate that a communication session has been requested by the communication device 102. For example, if the multimedia item is an audio content item, the communication device 104 plays the audio content item via a speaker. If the multimedia item is a video content item, the communication device 104 displays the item via a video monitor. In response to the multimedia item being rendered, the user of the communication device 104 can take appropriate action, such as accepting or denying the communication session request. If the request is accepted, the communication session is conducted between the initiating communication device 102 and the target communication device 104 via the network 110.

As described, the communication network 100 allows for multimedia items to be used as indicators of communication session requests, providing for an enhanced user experience. Further, a customer (such as the example target customer for the communications device 104) can adjust the network notification preference information 124 via one or more interfaces (not shown) provided by the service provider 120 to customize the multimedia items and various SAIN content information associated with particular target devices, particular requesting devices, user groups, or the like. For example, a customer at the target communication device 104 can adjust the notification preference information 124 so that a particular video item is displayed if the request comes from an initiating communication device associated with a particular user and if the request is targeted to a device capable of displaying video, such as a television and set top box or a computer. If the request is targeted to a device that is not capable of playing video, the notification preference information 124 can indicate another multimedia content item, such as an audio file. Thus, the notification indicator is flexible and customizable, allowing a customer to individualize her notification preferences. In addition, such one or more interfaces provided by the service provider 120 can allow the customer to provide the multimedia files, text substitution information, and service provider control logic stored at the multimedia content repository 126 and the multimedia server 130. This allows a customer to customize SAINs using multimedia and other content items created by the customer, further enhancing the customization options. The interface(s) by the service provider 120 for specifying and/or modifying the SAIN content may be implemented using a variety of technologies, such as (but not limited to) programmable machine interfaces, browser interfaces, voice response mechanisms, live representative contacts, or any combinations thereof.

In addition, in response to a communication initiation request, the service provider 120 can send different SAINs, each including a different URL or other content notification item, to multiple devices associated with a target user who is to be contacted. For example, in response to a single communication session initiation request, the service provider 120 can send different SAINs, with different URLs or other content items, to a computer, a cell phone, a wired phone, or other communication device 104. The different SAINs can be sent simultaneously or in sequence, based on the notification preference information 124 and configuration information.

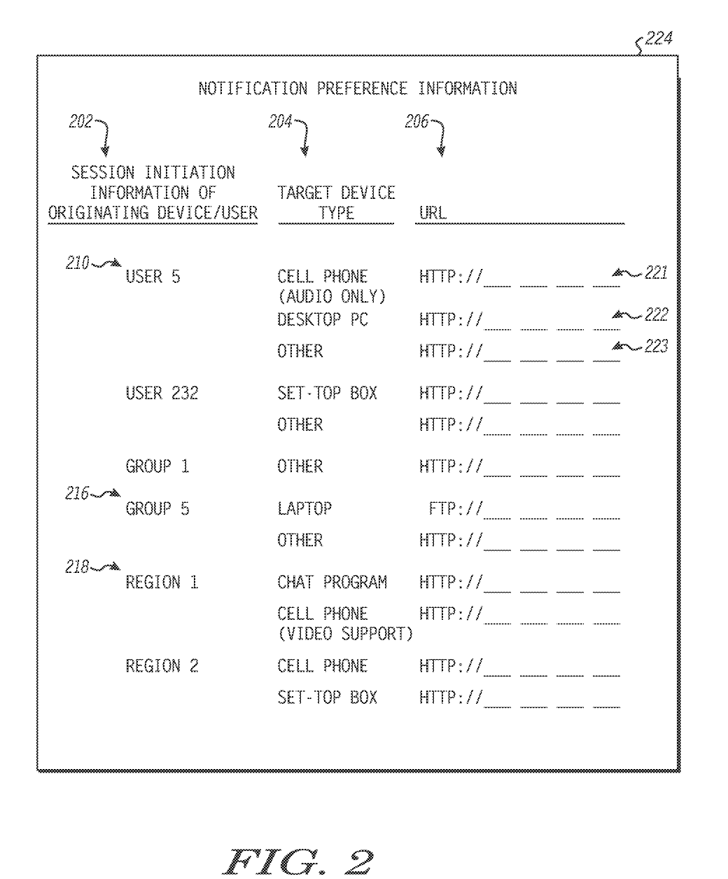

FIG. 2 illustrates a diagram of a particular embodiment of notification preference information 224. In particular FIG. 2 illustrates a data set of notification preference information 224 associated with a particular customer. The notification preference information 224 includes session initiation information 202, including information associated with an initiating user at the initiating communication device 102, target device type information 204, and URL information 206. The session initiation information 202 includes identifiers for particular customers, groups, or regions, as indicated by the customer identification information 122. The target device type information 204 includes identifiers for particular device types (such as, but not limited to device models and/or classes of devices) for the customer associated with the data set. In an embodiment, the target device type information 204 may be distinguished by a device address. For example, a cell phone can be identified based on the model of the cell phone associated with a phone number, while a computer device can be identified based on an internet address. Accordingly, a particular target device type set forth in the target device type information can be indicated by a network address and/or other additional information associated with the device. In addition, a user can register particular device types with the service provider 120 to associate particular URL address information with a particular device type. The URL information 206 includes identifiers for multimedia items associated with particular initiating users and device types.

In the illustrated embodiment of FIG. 2, the notification preference information 224 indicates multimedia items for a particular user (referred to for purposes of discussion as “User1”) based on an initiating customer, group, or region. Thus, set 210 indicates the URLs for communication session requests received from a customer labeled “User5.” Accordingly, if the service provider 120 receives a communication request targeted to User1 from User5 and targeted to User1's cell phone, the service provider 120 will provide the URL 221 as a portion of the SAIN. If communication request is targeted to User1's desktop PC, the service provider 120 provides the URL 222 as the SAIN. For all other target devices, the service provider 120 provides the URL 223.

Further, in the exemplary embodiment URLs can be associated with groups of users. Thus, set 216 indicates the URLs for communication requests received from customers associated with a group labeled “Group 5.” The notification preference information can be arranged in a hierarchical fashion, so that conflicts in the selection of URLs do not arise. Thus, in a particular embodiment if the notification preference information 224 indicates specific URLs for a user and also for a group associated with the user, the specific information for the user will take precedence. In an embodiment, User1 can customize rules to determine the hierarchy for selection of the URLs.

In addition, particular URLs can be associated with a region of the source of the communication request. Accordingly, set 216 indicates URLs for communication requests from a region labeled “Region1.” A region can be any geographic region, time zone, or the like, such as a continent, state, or area code region.

In an embodiment, the service provider 120 can provide an interface, such as a graphical user interface, for a customer to modify the notification preference information 224 associated with that customer. This allows customization of the SAIN for each customer. Thus, in an embodiment, the customer can set up the notification preference information 224 so that different video clips, audio clips, or other multimedia is displayed depending on the source of the incoming communication request and the target communication device.

In another embodiment, the customer can modify the notification preference information 224 so that identification information associated with a first user is displayed in response to an incoming communication request from a device associated with a second user. For example, if a first user, identified as “Anna” is visiting a second user, identified as “Wolfgang”, the customer could configure the notification preference information 224 so that, in response to a communication request from a device associated with Wolfgang, identification information is displayed indicating the communication request is coming from Anna. In still another embodiment, the notification preference information 224 can be configured to substitute a nickname for the user or customer identification name associated with a user at the service provider 120 or multimedia content server 130. Thus, the URL associated with a customer named “James” can refer to multimedia information that, when displayed, indicates a communication request has been received from “Jim” or “Jimmy.”

In another embodiment, the URLs of the notification preference information 224 can provide for different pronunciations of a user's name. For example, the service provider 120 can store multiple pronunciations of a user's name in a set of sound files at the multimedia content repository 126 or Multimedia Content Server 130. Further, each sound file can be identified by a URL stored at the notification preference information 224, and rendered at the target customer device in the audio format to indicate the communication request. This allows a user to be notified with different name pronunciations or other renderings depending on the source of the communication request.

For example, the initiating communication device 102 can be associated with the user USER5, whose name is “Cyrus.” The URL 221 can identify a sound file having a particular pronunciation of the name Cyrus, which will be rendered at the target user's cell phone in response to a phone call from Cyrus. Accordingly the target user can tailor the URL 221 for a particular pronunciation of the name. For example, the target user can set the URL 221 so that the rendered audio file pronounces the name as SIGH-ROOS. Alternatively, the target user can set the URL 221 so that the rendered audio file pronounces the name as SEE-ROOS. Another example usage is for the URL to be used to render associations or relations. For example, a call from the device associated with Cyrus may be rendered at a text and audio-only target device using a multimedia sound file and text to be presented as “Sara's brother” (in text and/or audio format).

The URL information can also identify particular video content items, including still pictures, video clips, or the like. For example, the URL 222 can identify a picture of the king Cyrus the Great. Accordingly, in response to a communication session request from the user Cyrus, the picture of Cyrus the Great will be rendered at the user's desktop computer.

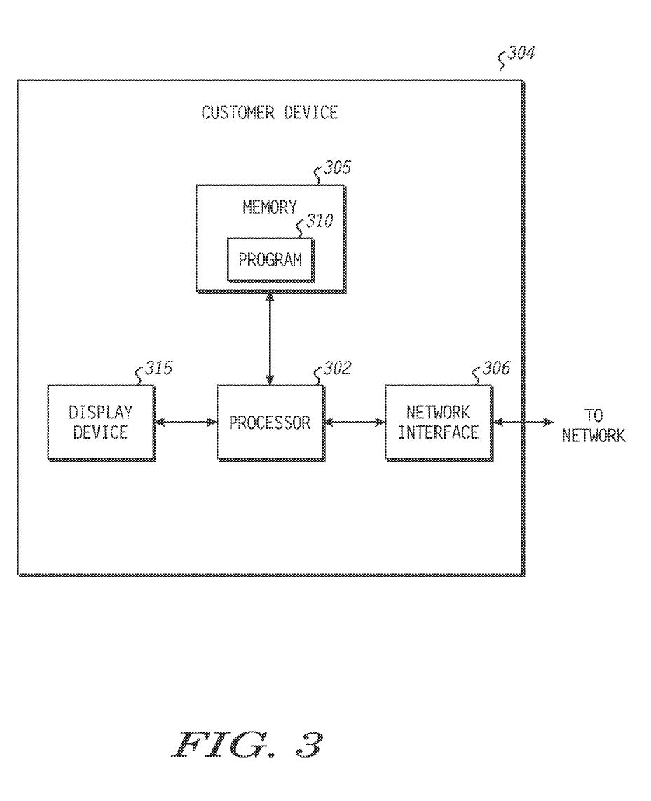

FIG. 3 illustrates a block diagram of a particular embodiment of a customer device 304, corresponding to the customer device 104, and including a processor 302, a memory 305, a network interface 306, and a display device 315. The memory 305 is accessible by the processor 302, which controls the network interface 306, and the display device 315.

The processor 302 can be a microprocessor, microcontroller, or other device that executes program instructions to control functions of the customer device 304. In particular, the processor 302 accesses a program 310 stored in the memory 305, and executes instructions of the program to perform one or more of the methods described herein. The memory 305 can be a random access memory (RAM), read-only memory (ROM), flash memory, or other time of memory to store the program 310.

The network interface 306 is configured to interface with the network 110. In particular, the network interface 306 provides a physical and link-layer interface with the network 110, and can receive and transmit packets via the network.

The display device 315 can be any type of device that can render multimedia information, including video, audio, or a combination thereof. Thus, the display device 315 can be one or more speakers, display monitors, or a combination thereof.

During operation, the processor 302 receives from the network 110, via the network interface 306, communication session requests. Further, the processor 302 receives from the service provider 120 URLs identified in the notification preference information 124, as described above with respect to FIGS. 1 and 2. In response to receiving this information, the processor 302 retrieves multimedia information from the network 110 identified by the URL and renders the multimedia information via the display device 315.

FIG. 4 illustrates a flow diagram of a particular embodiment of a method of providing notification of a communication session request. At block 402, a communication session request is received at a service provider from a source device, such as a telephone, mobile computing device, set top box, or the like. The communication session request includes address information indicating the source device and address information indicating the target device of the session request. The address information can be a telephone number, internet protocol (IP) address, email address, user identification value (e.g. a user name), or the like. At block 404, the service provider determines a first user based on the target address information.

At block 406, the service provider accesses notification preference information associated with the first user. The notification preference information can be customized by the first user to identify preferred content (such as text, audio URLs, video URLs, or any combination thereof) to be used for notification of the communication session request, depending on a number of criteria, including the source of the session request, the target device of the session request, a region associated with the request, or the like. At block 408, the service provider determines the content item based on the source address information of the communication session request. To determine the content item, the service provider can perform text substitution, translation, URL referencing, and other services to create session notification information and include the information in a SAIN. At block 410, the service provider provides the SAIN to the session request target device. The session request target device can render the SAIN by displaying or otherwise rendering text, by retrieving a multimedia item identified by a URL included in the SAIN, or the like.

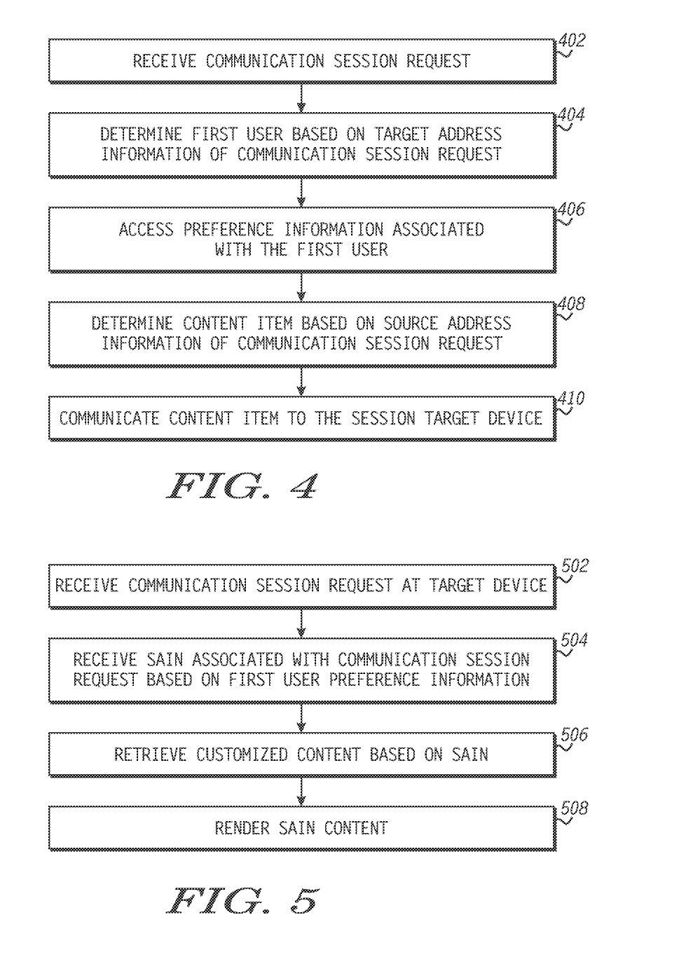

FIG. 5 illustrates a flow diagram of a particular embodiment of a method of receiving a communication session request at a target device. At block 502, the target device receives the communication session request from a service provider. At block 504, the target device receives a SAIN associated with the session request. The SAIN is identified by the service provider based on preference information associated with a user of the target device.

At block 506, the target device retrieves customized content based on the SAIN. This can include extracting text and other information included in the SAIN for display. In another embodiment, the target device can identify one or more URLs included in the SAIN and retrieve one or more multimedia items based on the URLs. In an embodiment, the multimedia items are retrieved from a network such as an IPTV network, Service Provider network or the Internet. The multimedia items can be audio files, video files, or the like. At block 508, the target device renders the customized SAIN content to indicate that the communication session request has been received.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method, comprising:
receiving a first communication session request comprising first address information indicating a session target and second address information indicating a first session source;
determining a first user based on the first address information;
accessing preference information associated with the first user to determine a first content item associated with the first session source; and
communicating the first content item to the session target to indicate the first communication session request.

2. The method of claim 1, wherein accessing preference information comprises:
determining a device type based on configured data associated with the first address information;
determining the first content item based on the device type.

3. The method of claim 2, wherein the device type is selected from the group consisting of: a computer, a telephone, a cell phone, a personal data assistant, a television, and a set-top box.

4. The method of claim 1, wherein the first content item is a multimedia content item

5. The method of claim 4 wherein the first content item is selected from the group consisting of an audio content item and a video content item.

6. The method of claim 1, wherein communicating the first content item comprises communicating a universal resource locator (URL) associated with the first content item.

7. The method of claim 1, wherein the second address information identifies a second user, and wherein accessing preference information comprises determining the first content item based on the second user.

8. The method of claim 1, wherein the second address information identifies a group of users, and wherein accessing preference information comprises determining the first content item based on the group of users.

9. The method of claim 1, wherein the second address information identifies a region, and wherein accessing preference information comprises determining the first content item based on the region.

10. The method of claim 1, further comprising:
receiving a second communication session initiation request comprising third address information indicating the session target and fourth address information indicating a second session source;
determining the first user based on the third address information;
accessing the preference information associated with the first user to determine a second content item associated with the second session source, the second content item different from the first; and
communicating the second content item to the session target to indicate the second communication session request.

11. A method, comprising:
receiving a communication request;
determining a communication target and a communication source based on the communication request;
accessing preference information associated with the communication target to determine a content item identifier based on the communication source; and
sending the content item identifier to the communication target.

12. The method of claim 11, wherein the content item identifier is a universal resource locator (URL).

13. The method of claim 11, wherein the content item identifier indicates a sound file.

14. The method of claim 13, wherein the sound file is indicative of a user name

15. The method of claim 13, wherein the sound file is indicative of a user association.

16. A method, comprising:
receiving a communication session request from a source device at a target device;
receiving a universal resource locator (URL) associated with the communication request, the URL based on preference information associated with a first user, the first user associated with the target device;
retrieving a multimedia item based on the URL; and
displaying the multimedia item at the target device to indicate reception of the communication session request.

17. The method of claim 16, wherein the URL is based on a type of the target device.

18. The method of claim 16, wherein the URL is based on a second user associated with the source device.

19. The method of claim 16, wherein the multimedia item is selected from the group consisting of an audio file and video file.

20. A computer readable medium storing instructions to manipulate a processor, the instructions comprising:
instructions to receive a communication session request comprising first address information indicating a session target and second address information indicating a session source;
instructions to determine a first user based on the first address information;
instructions to access preference information associated with the first user to determine a first content item associated with the session source; and
instructions to communicate the first content item to the session target to indicate the communication session request.

21. The computer readable medium of claim 20, wherein the instructions to access preference information comprise:
instructions to determine a device type based on the first address information;
instructions to determine the first content item based on the device type.

22. The computer readable medium of claim 21, wherein the device type is selected from the group consisting of: a computer, a telephone, a cell phone, a personal data assistant, a television, and a set-top box.

23. The computer readable medium of claim 20, wherein the first content item is selected from the group consisting of an audio file and a video file.

24. The computer readable medium of claim 20, wherein the instructions to communicate the first content item comprise instructions to communicate a universal resource locator (URL) associated with the first content item.

25. The computer readable medium of claim 20, wherein the second address information identifies a second user, and wherein the instructions to access preference information comprise instructions to determine the first content item based on the second user.
